(19) United States
(12) Patent Application Publication
(10) Pub. No.: US 2006/0261610 A1
(43) Pub. Date: Nov. 23, 2006

(54) Floor spring

(76) Inventors: Volker Bienek, Dortmund (DE); Stephan Gosch, Riepsdorf (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/569,662

(22) PCT Filed: Aug. 10, 2004
(86) PCT No.: PCT/EP04/08928

§ 371 Date: Feb. 24, 2006

(51) Int. Cl. E05B 15/02

(52) U.S. Cl. 292/340

(57) ABSTRACT

A floor spring includes a housing for receiving a closing mechanism having a closing shaft. The closing shaft can support a door, and the housing has a region surrounding the closing shaft. The floor spring further includes a cover component for covering the region surrounding the closing shaft. The cover component has an essentially U-shaped base unit, and an insert which is insertable into the base unit.

The invention relates to a floor spring having a housing for accommodating a closing mechanism, the housing being covered by a cover component in the region of a closing shaft, which supports a door or the like.

Such floor springs are well known. They present a housing which is surrounded by a cement case, the latter being insertable into an opening, which is recessed in the floor. The whole cement case, including the floor spring located therein, is covered at the top side by a cover plate, such that just this cover plate is visible from outside. As the cover plate can not be mounted until after the door or the like has been mounted to the floor spring and until after, for example, the closing speed has been set at the floor spring, the cover plate on the front side must present an oblong hole extending in the longitudinal direction to allow for mounting the cover plate to the housing of the floor spring, past the closing shaft.

The cover plate can be fastened either to the cement case or to the housing of the floor spring. As a requirement, the housing of the floor spring has to be adjustable within the cement case in all four directions in-plane and in conjunction with the above mentioned different fastening possibilities for the cover plate at the cement case or at the housing, the cover plate ends up having oblong holes of various sizes.

If the cover plate is fastened to the housing of the floor spring, the plate together with the housing may perform a possible adjusting movement of the housing within the cement case. As a consequence, the oblong hole is required to be large enough to allow the cover plate to be mounted past the closing shaft.

If, on the other hand, the cover plate is mounted to the cement case, in the event of an adjusting movement, the housing will perform a relative movement in relation to the cover plate, as the latter is secured to the cement case. In order to be able to guarantee the complete adjustment of the housing in this case, the oblong hole has to be increased by this additional adjusting path, as otherwise the closing shaft could hit the cover plate.

Furthermore, it is required that the oblong hole be covered by one or more suitable cover components, to protect the floor spring and especially a sealing, surrounding the closing shaft from impurities.

In practice one and the same floor spring will continue to be used with both, a spindle and a rigid shaft, such that for one and the same floor spring, depending on the shaft execution and fastening of the cover plate at the housing or at the cement case, different cover plates will be required resulting in increased expenses incurred in production and stock-keeping.

In addition these components have to be partially pre-mounted in the factory as mounting by the customer on-site has proven to fail for many different reasons.

Therefore, it is an object of the invention to create a cover component being universally usable, regardless whether the floor spring has a spindle or a rigid shaft, and regardless whether the cover plate is fastened to the cement case or to the housing of the floor spring, a cover component that does not require any pre-mounting by the manufacturer and allows for retrofitting even if the door is already installed.

This problem is solved for a floor spring of the type discussed in the opening paragraphs, in that the cover component is formed in two parts and essentially consists of a U-shaped base unit and of an insert which is insertable into the base unit.

A universally usable cover component is provided through the inventive embodiment, which can be used irrespectively of the floor spring construction, which does not require any pre-mounting by the manufacturer and which allows for installation even if the door is already installed.

The dependent claims represent further embodiments of the inventive subject matter.

According to an advantageous embodiment, it is intended that the base unit and the insert, in the assembled condition thereof, essentially have a rectangular peripheral contour. This allows for a simple and cost effective production of both components and likewise guarantees simplified stock-keeping.

As, advantageously, the base unit essentially is evenly surfaced and insertable into the insert, a cover component is created which requires very little space in the mounted condition.

If, according to one advantageous embodiment, the insert is insertable into the base unit such as to leave a circular opening for the passage of the closing shaft, a spindle or a rigid shaft can be used, depending on the requirements.

Preferably, the U-shaped base unit with the open side thereof can be slid onto the insert such as to be able to easily and simply install the cover component around the closing shaft.

If, according to one advantageous embodiment, the base unit, at the inside edges thereof which are engageable with the insert, is provided with concave shaped, semicircular recesses extending in the longitudinal direction, a simple and yet good fixing possibility for the insert at the base unit is created.

Moreover, the fixing can be improved if, according to one advantageous further development, the insert, at the outside edges thereof, presents lateral wings extending to the outside, which engage in the recesses at the inside edges of the base unit.

Advantageously, the base unit and the insert, at regions thereof oriented towards the closing shaft, are provided with a semicircular contour, the profile thereof being formed as a sealing lip which engages into a groove at the closing shaft. An excellent protection from penetration of impurities is guaranteed on account of this embodiment. The sealing lip can be formed like a rotary shaft seal type.

In particular, according to another advantageous further development, if the sealing lip is inclined upwards, a pocket is created at the end of the sealing lip where impurities can accumulate. Thus, infiltration of impurities into the floor spring can be prevented effectively.

In order to guarantee a reliable fixing of the base unit and the insert, according to one advantageous embodiment, it is intended that the insert, at the rear region of the outside edges thereof, is provided with one opening respectively, which is latchable with one respective latching projection provided at the inside edges of the base unit. Advantageously, inserting chamfers are provided at the base unit, to allow for easy introduction of the base unit and the insert.

According to one preferred further development, the insert and the base unit, at the ends turned away from the closing shaft, are provided with predetermined breaking points. Thus the possibility is provided to simply adapt the length of the base unit und insert to local conditions.

Advantageously, the insert has a smaller thickness than the base unit. On account of this simple design, it is possible to clamp the base unit and insert with a single screw, as, due to the thinner insert, the latter will clamp the base unit when tightening the screw.

Preferably, the inventive cover component will be manufactured as injection-moulded part from plastic material, such as POM. This guarantees a simple and cost effective production even with large quantities.

Further characteristics and advantages of the inventive cover component will result from the following description of one preferred exemplary embodiment, in which:

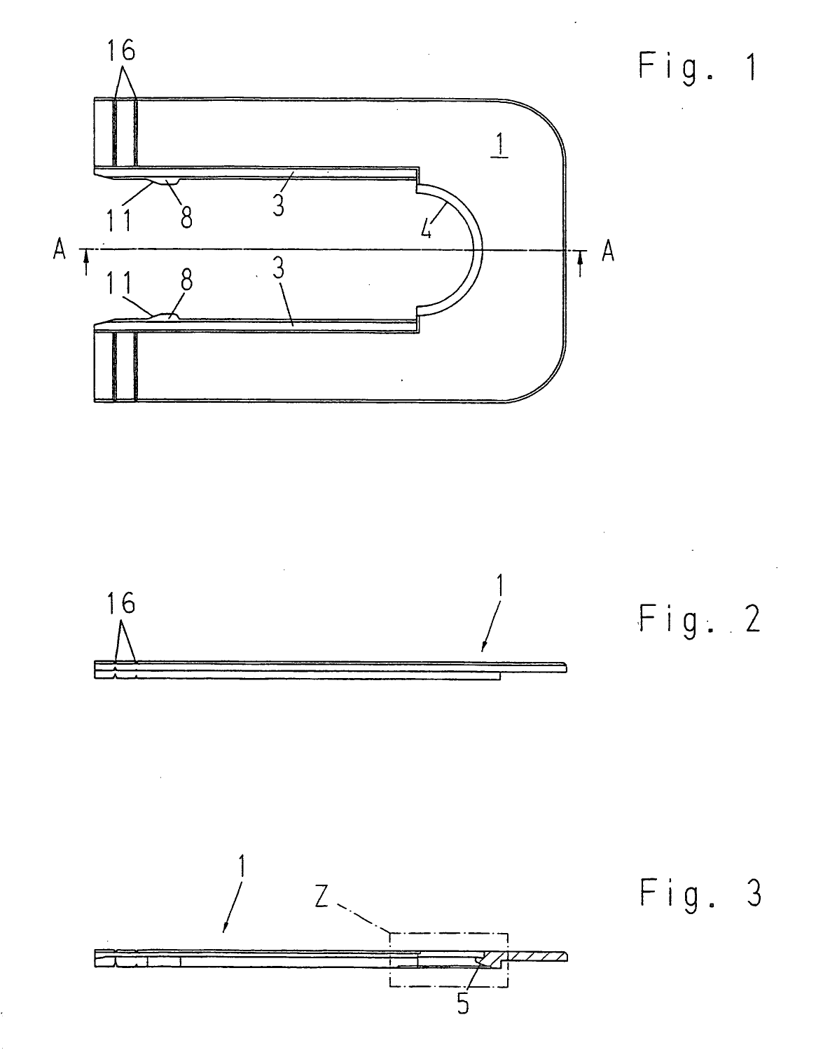

FIG. 1 shows a top view on the inventive base unit;

FIG. 2 shows a lateral view of the inventive base unit;

FIG. 3 shows a section through the inventive base unit along line A-A of FIG. 1;

FIG. 4 shows a rear view of the inventive base unit;

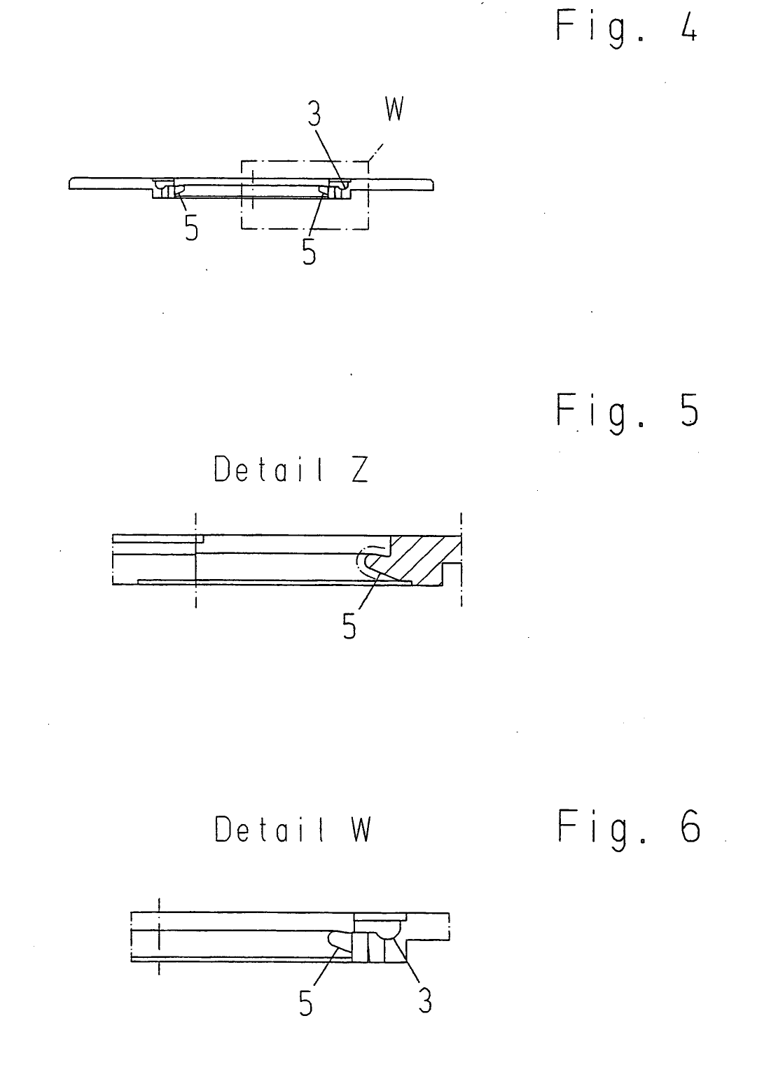

FIG. 5 shows the detail Z of FIG. 3;

FIG. 6 shows the detail W of FIG. 4;

FIG. 7 shows a view from below of the inventive base unit;

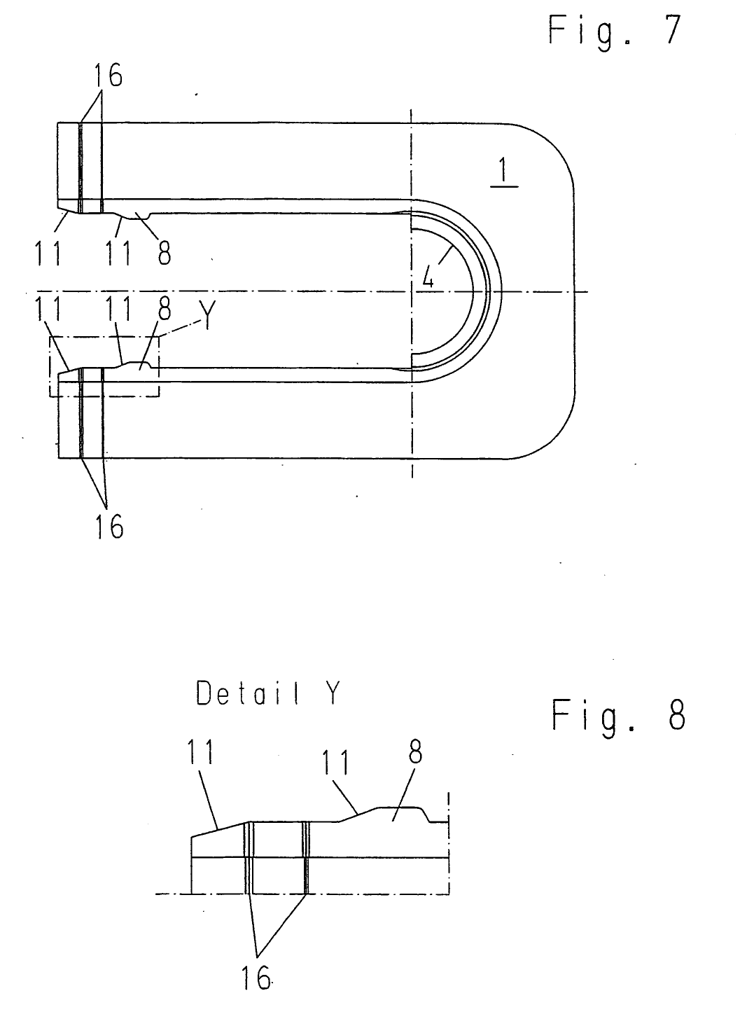

FIG. 8 shows the detail Y of FIG. 7;

FIG. 9 shows a top view on the inventive insert;

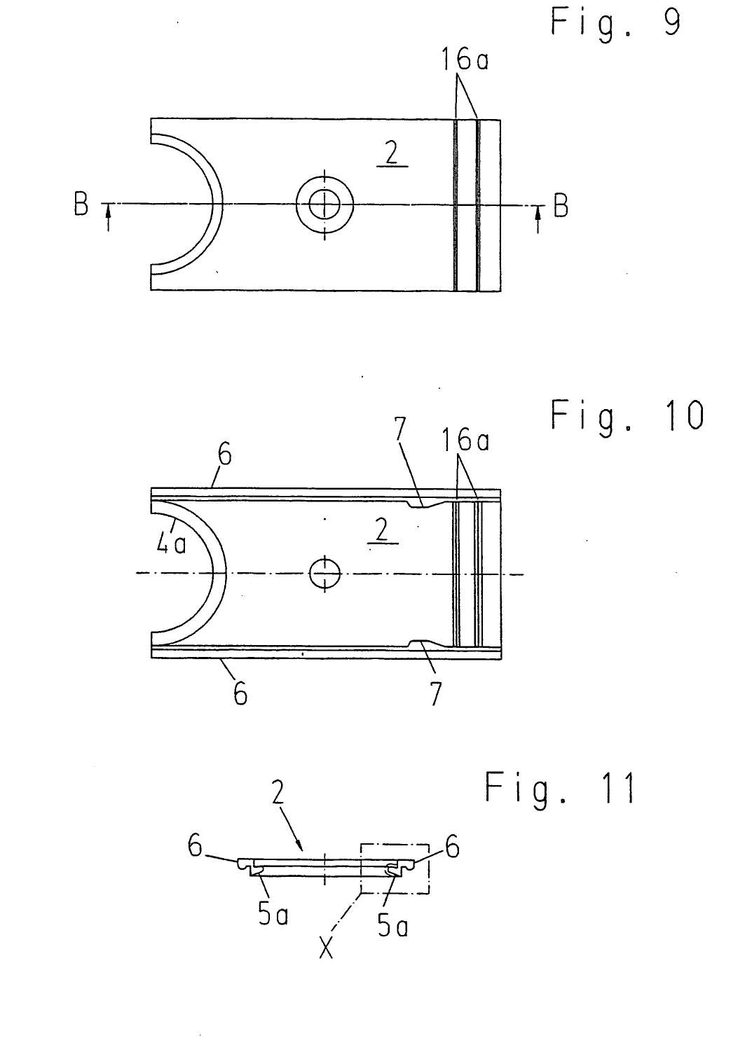

FIG. 10 shows a view from below of the inventive insert;

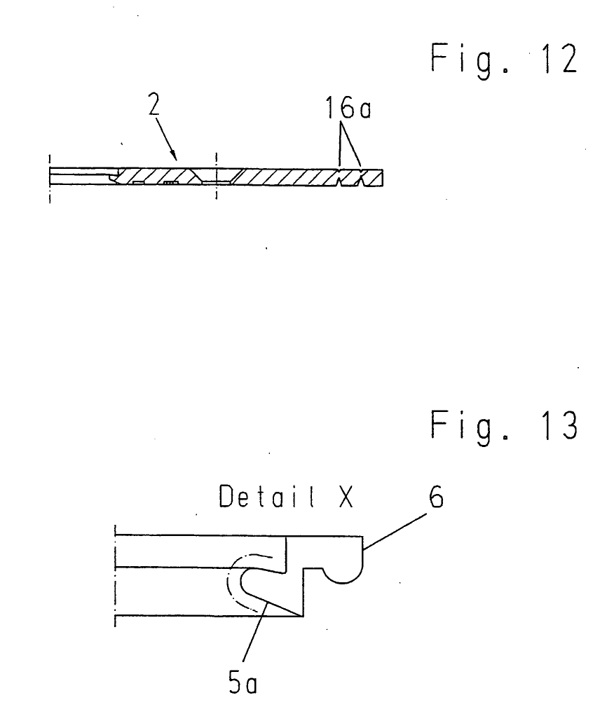

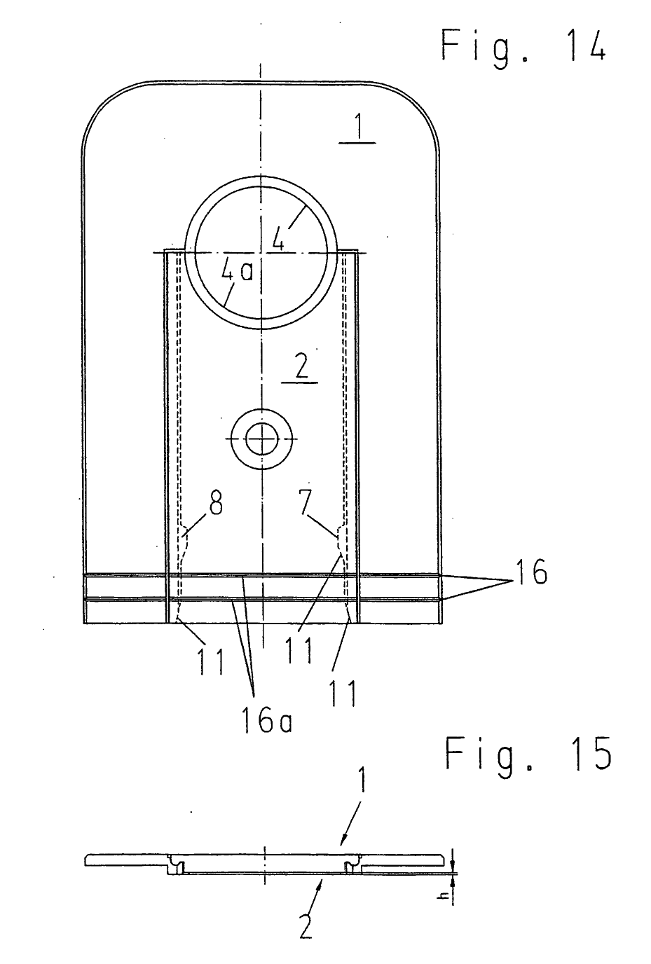

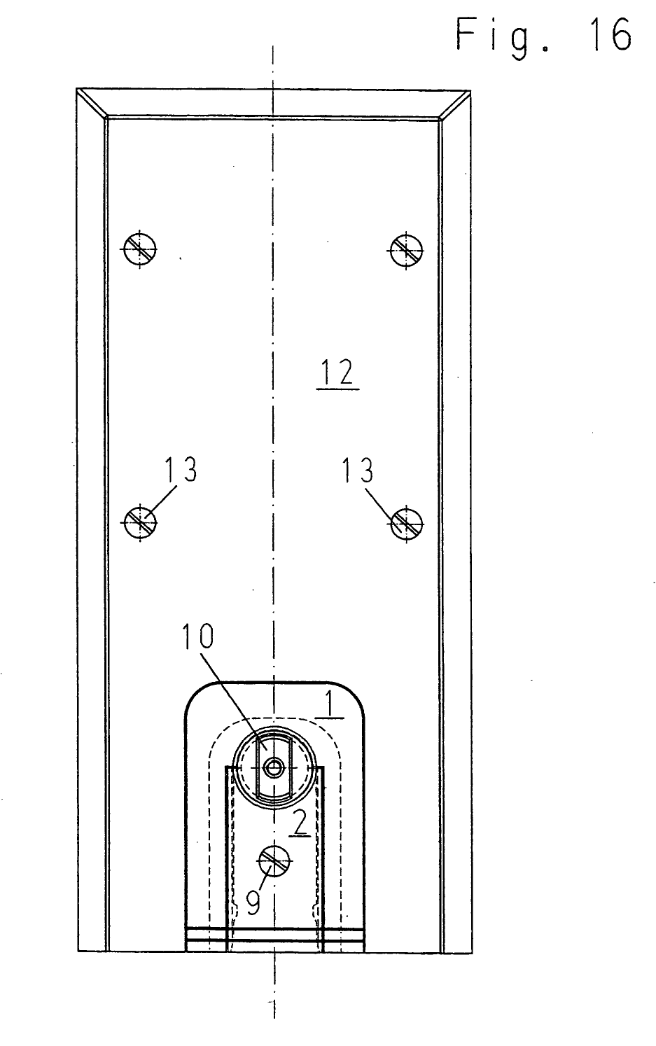

FIG. 11 shows a front view of the inventive insert;

FIG. 12 shows a cross-section through the inventive insert along line B-B of FIG. 9;

FIG. 13 shows the detail X of FIG. 11;

FIG. 14 shows a top view on the base unit, from above, with the insert being inserted;

FIG. 15 shows a rear view of the base unit with the insert being inserted;

FIG. 16 shows a top view on a floor spring, the base unit, the insert and the cover plate being installed;

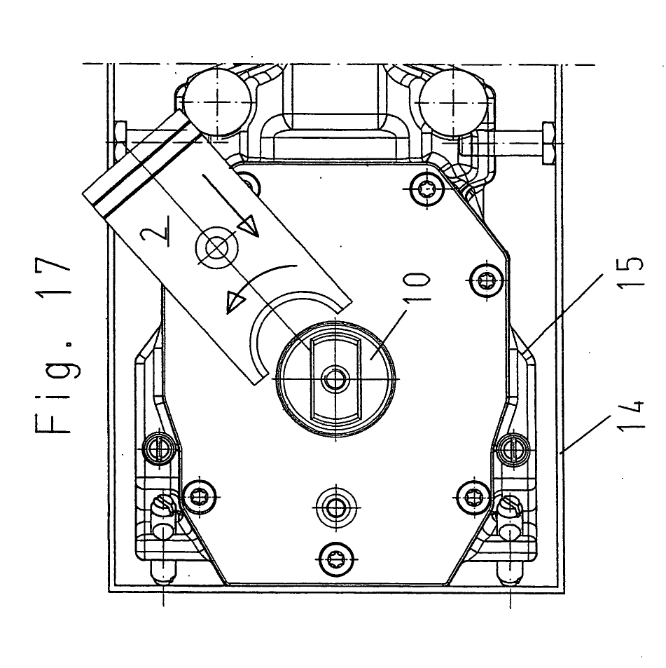

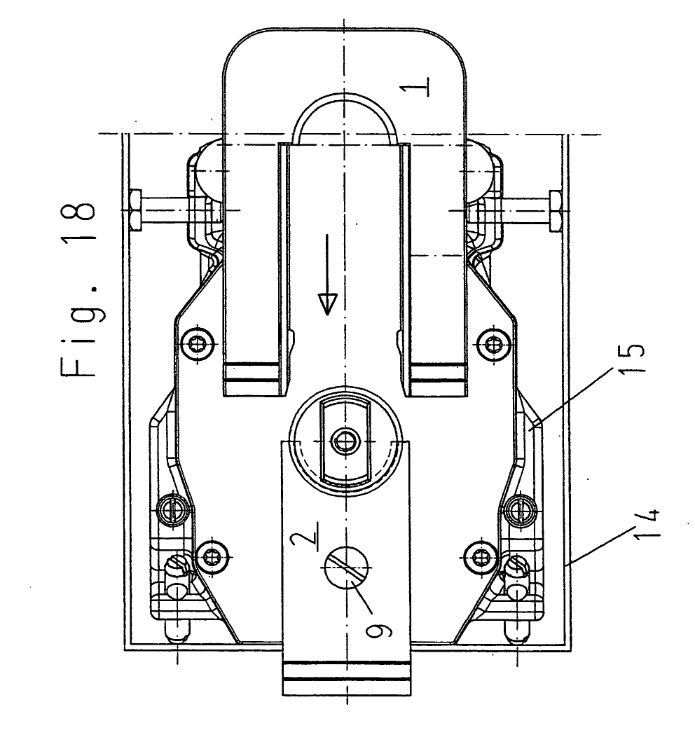

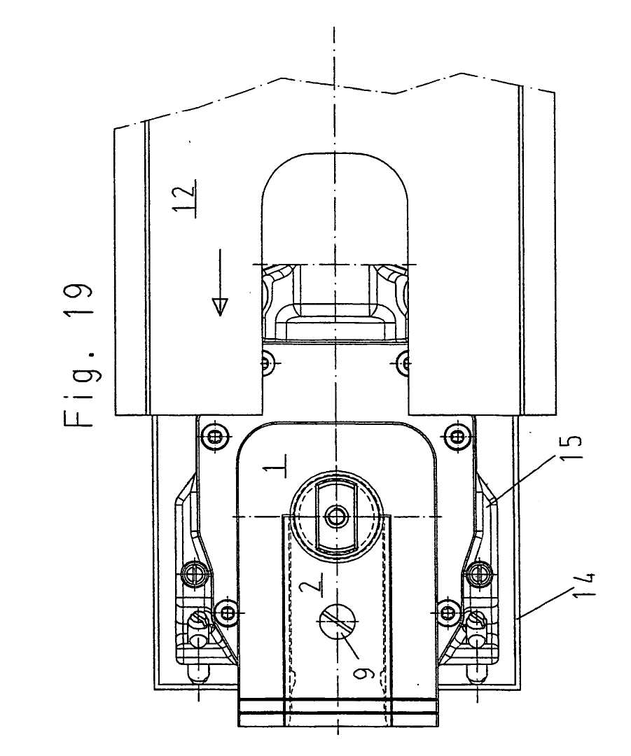

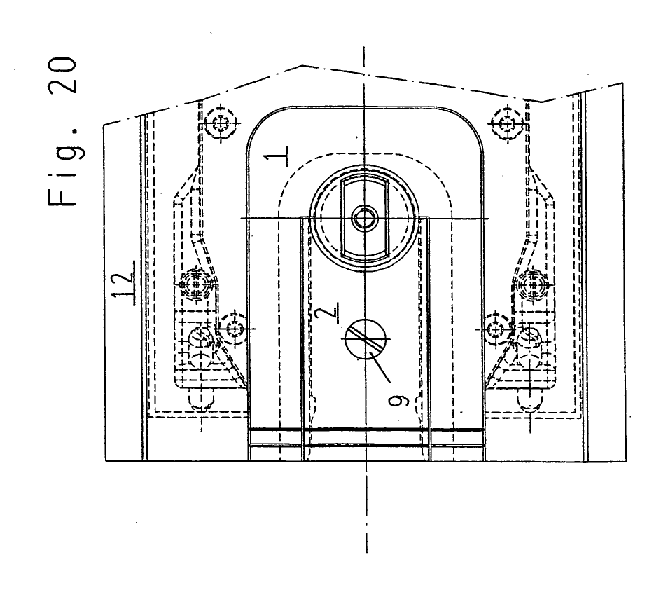

FIG. 17-20 show different states during mounting of the base unit, insert and cover plate.

The inventive cover component consists of a base unit 1 and an insert 2. The base unit 1 is illustrated in a variety of views in FIGS. 1 to 8, whereas the insert 2 is shown in a variety of views in FIGS. 9 to 13.

In the following, the base unit 1 will be described first. The base unit 1 is produced for example by injection moulding from plastic material, e.g. POM. It is formed as an essential planar plate having an oblong opening on one side, which results in an essentially U-shaped form, when seen in a top view. At the inside edges of the opening, the base unit 1 is respectively provided with concave shaped, semicircular recesses 3 extending in longitudinal direction of the opening. The front side of the opening terminates in a semicircular contour 4, when seen in a top view. The contour 4 is provided with a sealing lip 5 oriented to the inside and inclined upwards (compare FIG. 5). The sealing lip 5, which in profile can be formed like a rotary shaft seal, engages into a non-illustrated groove of a closing shaft 10 of the floor spring and thus prevents impurities from infiltrating. In the rear region on each side, at the inside edges of the opening in the base unit 1, respectively one latching projection 8 is provided. Moreover, inserting chamfers 11, facilitating the assembly of the base unit 1 and the insert 2, are disposed at the inside edges of the opening. For adapting the length of base unit 1 to the respective conditions, the base unit 1, at the free end thereof, is provided with predetermined breaking points 16 which allow for an easy shortening of the legs of the base unit 1.

The insert 2, insertable into the base unit 1, is illustrated in FIG. 9 to 13. Like the base unit 1, it consists of an injection-moulded part, for example made from POM, and essentially presents a rectangular shape with a semicircular contour 4a at one narrow side. The insert 2, at the outside edges thereof, is provided with wings 6 extending to the outside, which are engageable with recesses 3 at the inside edges of the base unit 1. The wings' 6 contour is such that they fit into the recesses 3. Through the cooperation between the recesses 3 at the base unit 1 and the wings 6 at the insert 2, a reliable fixing of the both components can be achieved. The semicircular contour 4a at the narrow side of the insert 2 forms a sealing lip 5a, and the form thereof matches the contour 4 of the sealing lip 5 at the base unit 1. An opening 7 is provided in the region of the wings 6 in an end portion of the insert 2, which opening, for latching between the base unit 1 and the insert 2, can engage with the latching projections 8 at the base unit 1, and thus prevents mutual displacement of the two components. Moreover, predetermined breaking points 16a are provided at the insert 2 allowing for adapting the length to the local conditions as with the base unit 1.

The cover component consisting of base unit 1 and insert 2 is shown in the assembled state in FIGS. 14 and 15. The recesses 3 at the base unit 1 are engaged with the wings 6 at the insert 2 and the semicircular contours 4 and 4a leave an open space for the passage of the closing shaft 10. As can be also seen in FIG. 15, the insert 2 has a smaller height than the base unit 1 resulting in a height difference h, the purpose thereof being explained later in conjunction with the FIGS. 17 to 20.

FIG. 16 shows a top view on the completely mounted floor spring, the door has been omitted for clarity's sake. The not visible floor spring is covered by a cover plate 12 and extends with the closing shaft 10 thereof through the cover component, consisting of base unit 1 and insert 2. The insert 2 of the cover component is fastened to the housing of the floor spring by means of a screw 9 and, through the height difference h, already mentioned, between the base unit 1 and the insert 2, clamps the whole cover component.

Now the installation of the cover component will be explained in conjunction with FIGS. 17 to 20. When installing the cover component, a closer housing 15 of the floor spring is fixed at the bottom of a cement case 14 and aligned therewith.

First the insert 2, as shown in FIG. 17, for example inclined from the top right side, is slid close to the closing shaft 10 and pivoted to the left in a circular arc-like movement, as indicated by the arrow in FIG. 17, until the insert 2 is aligned parallel to the closer housing 15. Then, the insert 2 is preliminary fixed to the closer housing 15 with the screw 9. At this time the screw 9 will not be tightened, i.e. the insert 2 can still be moved and displaced in height. Subsequently, the base unit 1 will be slid onto the insert 2, whereby the recesses 3 will engage with the wings 6. At the end of the inserting movement, the latching projections 8 at the base unit 1 snap into openings 7 at the insert 2 and thus fix base unit 1 and insert 2 together to form one unit. After the base unit 1 has snapped into the insert 2, the screw 9 is tightened and therefore the base unit 1 is clamped above the insert 2. A defined clamping of the cover component is achieved through the height difference h between the base unit 1 and the insert 2. As the insert 2 is less high than the base unit 1, the insert 2 is pushed downwards and thus simultaneously clamps the base unit 1, when tightening the screw 9. After tightening of the screw 9, the cover plate 12 will be slid under the cover component and fastened to the cement case 14, respectively to the closer housing 15 with attachment screws 13.

As established in the above description, smooth mounting will be possible even with an already installed door. Likewise, a universal application of the inventive cover component with both spindles and rigid shafts is made available, as well as fastening the cover plate 12 at the cement case 14 or at the closer housing 15.

### REFERENCES

1 base unit

2 insert

3 recesses

4, 4a semicircular contour

5, 5a sealing lip

6 wings

7 opening

8 latching projection

9 screw

10 closing shaft

11 inserting chamfer

12 cover plate

13 attachment screw

14 cement case

15 closer housing

16, 16a predetermined breaking points

h height difference

1.-14. (canceled)

15. A floor spring comprising:
a housing for receiving a closing mechanism having a closing shaft which can support a door; and
a cover for covering the housing, the cover comprising a cover component surrounding the closing shaft, the cover component comprising a generally U-shaped base unit having an oblong opening, and an insert insertable into the oblong opening of the base unit.

16. The floor spring of claim 15 wherein, when the insert is inserted in the base unit, the base unit and the insert present a generally rectangular peripheral contour.

17. The floor spring of claim 15, wherein the base unit is an essentially planar plate.

18. The floor spring of claim 15 wherein, when the insert is inserted in the base unit, the base unit and the insert form a circular opening for passage of the closing shaft.

19. The floor spring of claim 15, wherein the base unit is slidable onto the insert.

20. The floor spring of claim 18, wherein the base unit has a first end and two spaced inside edges extending inward from the first end and engageable with the insert, each of the inside edges having a concave, arcuately profiled recess.

21. The floor spring of claim 20, wherein the insert has two laterally extending wings for engaging respective said recesses.

22. The floor spring of claim 21, wherein the base unit and the insert each has a portion with a semi-circular contour facing the circular opening, said portions being formed as sealing lips which can engage a groove of the closing shaft.

23. The floor spring of claim 22, wherein each of the sealing lips is inclined upward.

24. The floor spring of claim 20, wherein each of the inside edges has a latching projection, the insert having opposed outside edges with respective recesses for receiving respective said latching projections.

25. The floor spring of claim 20, wherein each of the inside edges has a chamfer near the first end of the base unit.

26. The floor spring of claim 24, wherein the insert has a first end which is opposite to the portion with the semi-circular contour, and at least one of the first end of the base unit and the first end of the insert has a predetermined breaking point.

27. The floor spring of claim 15, wherein the base unit has a thickness and the insert has a thickness which is smaller than the thickness of the base unit.

28. The floor spring of claim 15, wherein each of the base unit and the insert is made from plastic material.

29. The floor spring of claim 28, wherein each of the base unit and the insert is made from polyoxymethylene.

30. A floor spring comprising:
a housing for receiving a closing mechanism having a closing shaft which can support a door; and
a cover for covering the housing, the cover comprising a cover component surrounding the closing shaft, the cover component comprising a generally U-shaped base unit having an oblong opening, and an insert insertable into the oblong opening of the base unit,
wherein the base unit has a first end and two spaced inside edges bounding the oblong opening and extending inward from the first end and engageable with the insert, each of the inside edges having a concave, arcuately profiled recess.
